(19) United States
(12) Patent Application Publication
(10) Pub. No.: US 2024/0391344 A1
(43) Pub. Date: Nov. 28, 2024

(54) Method and System for Authentication of Charging a Vehicle, Vehicle and Charging Pile

(71) Applicant: Bayerische Motoren Werke Aktiengesellschaft, Muenchen (DE)

(72) Inventors: Daisy DAI, Beijing (CN); Alexander EWALD, Muenchen (DE); Nan JIANG, Beijing (CN); He MIAO, Shunyi district, Beijing (CN); Apple WANG, Beijing (CN)

(21) Appl. No.: 18/697,044

(22) PCT Filed: Aug. 17, 2022
(86) PCT No.: PCT/EP2022/073014

§ 371 Date: Mar. 29, 2024

(30) Foreign Application Priority Data
Sep. 30, 2021 (CN) 202111156836.7

(51) Int. Cl. B60L 53/65; B60L 53/16; B60L 53/30; B60L 53/62; B60L 53/66; B60L 53/68

(52) U.S. Cl. CPC B60L 53/65; B60L 53/16; B60L 53/305; B60L 53/62; B60L 53/66; B60L 53/68; B60L 2240/72; B60L 2240/80

(57) ABSTRACT

A method for authentication of charging a vehicle includes: transmitting a vehicle identification number and at least one vehicle state information from the vehicle to a charging pile after plugging a charging gun of the charging pile into the vehicle; sending, by the vehicle, its vehicle state information to a remote server; sending, by the charging pile, the vehicle identification number and the vehicle state information derived from the vehicle to the remote server; comparing the vehicle state information sent by the vehicle with the vehicle state information sent by the charging pile for the vehicle identification number in the remote server; and passing the authentication if at least one item in the vehicle state information matches. An additional safety mechanism is realized based on the existing communication standards, and ensures safety in a simple and reliable manner without modifying the charging connection assembly.

### TECHNICAL FIELD

The present disclosure relates to a method for authentication of charging a vehicle, a vehicle, a charging pile and a system for authentication of charging a vehicle.

### BACKGROUND ART

Nowadays, in order to charge a vehicle, the vehicle user usually needs to insert a card, enter a password, or scan a QR code for authentication and verification. In order to avoid these cumbersome operations, a plug-and-charge (Easy charge or Plug&Charge) charging solution has been developed to enable that charging may be performed by plugging the charging gun into a charging port of the vehicle without cumbersome operations by the user. This plug-and-charge charging solution only simply uses a vehicle identification number (VIN) for identification, such that a payment bill or direct debit is generated for the user account associated with the vehicle identification number after the vehicle identification number is verified. However, since the vehicle identification number is required to be displayed on the windshield, it is likely to be embezzled, infringed, or subjected to relay attacks implemented by others, so that there is a great safety risk, which might cause property loss to the vehicle user.

### CONTENT OF THE DISCLOSURE

The task of the present disclosure is to provide a plug-and-charge charging solution with improved safety.

In order to achieve this task, the present disclosure provides a method for authentication of charging a vehicle, a vehicle, a charging pile and a system for authentication of charging a vehicle, which can realize an additional safety mechanism based on the existing communication standards, and ensure the property safety in a simple and reliable manner without modifying the charging connection assembly.

According to a first aspect of the present disclosure, a method for authentication of charging a vehicle is provided. The method comprises:
transmitting a vehicle identification number and at least one vehicle state information from the vehicle to a charging pile after plugging a charging gun of the charging pile into the vehicle;
sending, by the vehicle, its vehicle state information to a remote server;
sending, by the charging pile, the vehicle identification number and the vehicle state information derived from the vehicle to the remote server;
comparing the vehicle state information sent by the vehicle with the vehicle state information sent by the charging pile for the vehicle identification number in the remote server; and
pass the authentication if at least one item in the vehicle state information matches.

In the present disclosure, the vehicle is to be understood as an electric vehicle or an electrically driven vehicle, for example a battery electric vehicle (BEV) or a plug-in hybrid electric vehicle (PHEV) with an internal combustion engine and an electric drive device. The vehicle may be constructed as any type of vehicle, by means of which one or more persons and/or goods may be transported. The vehicle is particularly a car, a truck, a motorcycle, a bus or the like. Here, the vehicle is driven at least occasionally using a battery. The battery is particularly referred to as a complete vehicle power battery, which may include a plurality of power battery cells. The battery is charged by connecting to a charging pile. The charging pile may be understood as a charger or a charging device for charging the battery of the vehicle. The charging pile may be constructed in any form, for example a wall-mounted battery charger, a single charging pile, or a charging pile in a charging station.

According to the present disclosure, when the vehicle or its battery is charged, it is necessary to plug the charging gun of the charging pile into the vehicle. At this time, communication between the vehicle and the charging pile may be performed based on the existing communication standard. In order to implement the plug-and-charge charging solution, the present disclosure provides that: at least one vehicle state information is also transmitted from the vehicle to the charging pile in addition to the vehicle identification number. Here, the vehicle state information may describe a current physical state of the vehicle, such as a location state, an electrical state, a connection state and an operation state. In particular, the vehicle state information should include certain dynamic rather than constant information, which enables the vehicle state information effectively or with a high probability to allow the vehicle to be distinguished from other vehicles and difficult to be known or embezzled by others.

In order to perform identity authentication, the vehicle sends its vehicle state information to a remote server, and the charging pile sends the vehicle identification number and the vehicle state information derived from the vehicle to the remote server. It should be noted that, since the vehicle identification number is constant for a vehicle, it may be constantly stored in the remote server in advance. However, it is also possible for the vehicle to send its vehicle identification number and vehicle state information to the remote server. Here, the term “remote server” refers to a group of functionally related electronic components, for example a computer system in a network environment, wherein the computer system may include hardware and software components or alternatively only include software components that perform certain functions when executed. The remote server may be integrated with a database management system and one or more associated databases. The remote server may also preferably be constructed as a cloud server, wherein a virtual server or virtual dedicated server that provides extensible computing services on the cloud server may independently provide Internet services such as computing, storage, backup, sharing, push, and processing.

During the authentication process, the vehicle state information sent by the vehicle is compared with the vehicle state information sent by the charging pile for the same vehicle identification number in the remote server; and the authentication is passed if at least one item in the vehicle state information matches. Here, the authentication is passed, which means that the identity of the vehicle is successfully verified, and the charging pile is allowed to charge the vehicle. For example, the remote server may return a signal representing that the authentication is passed to the charging pile, and the charging pile may start charging the vehicle accordingly. Here, at least one item in the vehicle state information matches, which means that one or more values among all vehicle state information are the same or within an allowable error range. For example, the value difference does not exceed 1%, 5% or 8%, or the position difference does not exceed 5 meters, 10 meters or 20 meters, etc. Preferably, the authentication fails if all the vehicle state information does not match. At this time, the remote server may return a signal representing that the authentication fails to the charging pile, so as to prohibit or stop the charging pile from charging the vehicle.

In the present disclosure, the vehicle user only needs to plug the charging gun of the charging pile into the vehicle so as to automatically authenticate the charging of the vehicle, thereby realizing efficient plug-and-charge and providing significant convenience and comfort to the vehicle user without cumbersome operations by the user. By using the at least one vehicle state information, an additional safety mechanism is implemented in a simple and reliable manner, thereby avoiding embezzlement, infringement, or relay attacks implemented by others and ensuring property safety for the vehicle user. Moreover, the present disclosure, which only uses the existing communication functions and technical means on the vehicle and the charging pile, without modifying the charging connection assembly, and particularly without having to install an additional communication device or communication cable, and is only based on the communication standard that has been applied on the vehicle and the charging pile, may be applied and further promoted on the vehicles and the charging piles at a favorable cost.

According to one embodiment of the present disclosure, the at least one vehicle state information is a real-time vehicle state information. Here, in the case of using a real-time vehicle state information for authentication, the temporal effect of the vehicle state information is advantageously utilized to further reduce the safety risk. In particular, the vehicle state information is provided with a time stamp such that whether the time stamp has expired is additionally checked in the remote server. Here, the temporal effect is advantageously embodied by means of a time stamp. By checking the vehicle state information, it is possible to effectively exclude the possibility of illegal use of expired information or data. Here, since different vehicle state information might have different update mechanisms or update times, it is preferable to provide each vehicle state information with a time stamp, and to check these time stamps respectively when the vehicle state information is compared. Particularly advantageously, the time stamp is first checked before the vehicle state information is compared. Specifically, a time threshold is preset, for example 15 seconds, 1 minute, 5 minutes, etc. When the time stamp is checked, it is calculated whether the time interval between the current time and the time presented by the time stamp exceeds the time threshold. It is also advantageous to compare other vehicle state information or to request the vehicle state information again if the time stamp has expired.

According to one embodiment of the present disclosure, the vehicle state information includes one or more of the following: a current charged state of the battery, a current voltage of the battery, charging times of the battery, a plug state, a measured value of a charging voltage, a measured value of a charging current, and location data; and/or the vehicle identification number is a vehicle unique identification number, a vehicle frame number or a vehicle engine number. In the present disclosure, it is particularly advantageously provided that one or more of current state of charge of battery, current voltage of battery, charging times of battery, plug state, measured value of charging voltage and measured value of charging current as the vehicle state information used in authentication, with the reason that these data is the data that is originally required to be transmitted between the vehicle and the charging pile, or can be transmitted based on existing communication standard when the vehicle is charged. Moreover, these data usually do not pertain to private data of the user, so that it is not likely to cause leakage of user privacy. The current state of charge of the battery may include a state of charge of the complete vehicle power battery and/or a state of charge of the power battery cells; the current voltage of the battery may include a current voltage of the complete vehicle power battery and/or a current voltage of the power battery cells. After charging starts, it is also possible to use a measured value of charging voltage and a measured value of charging current.

According to one embodiment of the present disclosure, in the case of using the location data as the vehicle state information, the vehicle only sends the location data to the remote server, such that the remote server correspondingly compares the location data sent by the vehicle with the location data of the charging pile stored in the remote server. Since the vehicle is required to be proximate to the charging pile upon charging, the location data of the vehicle is substantially equivalent to the location data of the charging pile. Thereby, the location data from the vehicle may also be compared with the pre-stored location data of the charging pile in the remote server without transmitting the location data between the vehicle and the charging pile. This embodiment, which is not restricted by the limited fields specified by the communication standard between the vehicle and the charging pile, is also of prominent significance for the safety of authentication.

According to one embodiment of the present disclosure, in the case that the authentication fails before charging starts, the charging pile first starts charging the vehicle, and the authentication is attempted again during the charging. Since the vehicle and the charging pile both have to communicate with the remote server, there might be a certain time delay. In order to avoid that the vehicle user with a misunderstanding that the charging pile does not respond in time repeatedly plugs and unplugs the charging gun, it is preferable to provide that charging is first started temporarily and the authentication is attempted again during the charging.

According to one embodiment of the present disclosure, the vehicle sends its vehicle state information to a vehicle back-end server, the charging pile sends the vehicle identification number and the vehicle state information derived from the vehicle to a charging operator server, and the comparison of the vehicle state information is implemented in one of the vehicle back-end server and the charging operator server. Here, in order to protect the information of the vehicle user on the one hand and allow for utilizing the data services available in the vehicle manufacturer or the vehicle service provider on the other hand, the remote server is separately implemented in a vehicle back-end server and a charging operator server, wherein the vehicle sends its vehicle state information to the vehicle back-end server, the charging pile sends the vehicle identification number and the vehicle state information derived from the vehicle to the charging operator server, and the comparison of the vehicle state information is implemented in one of the vehicle back-end server and the charging operator server. For example, the charging operator server may request the vehicle state information associated with the vehicle identification number from the vehicle back-end server so as to perform the comparison. It is also possible that the charging operator server only forwards the obtained vehicle identification number and vehicle state information to the vehicle back-end server, and if at least one item in the vehicle state information matches, the vehicle back-end server sends a signal presenting that the authentication is passed to the charging operator server, and the charging operator server allows the charging pile to charge the vehicle accordingly.

According to one embodiment of the present disclosure, the vehicle sends its vehicle state information to the vehicle back-end server periodically or in response to plugging of the charging gun into the vehicle.

According to one embodiment of the present disclosure, the communication between the vehicle and the charging pile is implemented via CAN line, PLC line, RS-485 line or Ethernet line, preferably the communication is performed in accordance with the GB/T27930-2015 standard; and/or the vehicle and the charging pile are implemented in accordance with GB/T 18487.1-2015, CCS 1, CCS 2, CHAdeMO or ChaoJi standard. In the present disclosure, the vehicle identification number and the at least one vehicle state information may be transmitted by means of a CAN line (here a CAN line independent of the powertrain control system), a PLC line, an RS-485 line or an Ethernet line, particularly transmitted in accordance with the GB/T27930-2015 standard. The present disclosure is preferably implemented to provide the vehicle and the charging pile in a DC charging scenario, and particularly in accordance with GB/T 18487.1-2015, CCS 1, CCS 2, CHAdeMO or ChaoJi standard.

According to a second aspect of the present disclosure, a vehicle configured to implement the method for authentication of charging a vehicle according to the present disclosure is provided. The vehicle comprises:
a battery management unit configured to communicate with a charging pile after plugging a charging gun of the charging pile into the vehicle, so as to transmit a vehicle identification number and at least one vehicle state information; and
a wireless communication unit, configured to communicate with a remote server to send the vehicle state information, wherein the vehicle state information is used to compare with the vehicle state information sent by the charging pile for authentication.

In the vehicle according to the present disclosure, the battery management unit may be a BMS (Battery Management System), which performs real-time monitoring and SOC estimation on the parameters of the power battery of the electric vehicle, and can communicate with the charging pile through the CAN line. The battery management unit may detect current state of charge of battery, current voltage of battery, charging times of battery, plug state, measured value of charging voltage and measured value of charging current and may transmit the same to the charging pile. The wireless communication unit is also referred to as a vehicle-mounted communication terminal, also known as a vehicle-mounted T-BOX (Telematics Box), which may support any radio standard here, such as Bluetooth standard, mobile radio standard such as GSM, GPRS, EDGE, 3G, 4G, LTE and 5G, a near field standard (NFC) and/or a wireless local area network (WLAN) standard according to a IEEE-802.11 family. The wireless communication unit may collect the vehicle bus data, obtain the vehicle state information of a vehicle sensor such as a location sensor and a battery management unit, and send the vehicle state information to the remote server through the wireless communication network.

According to one embodiment of the present disclosure, the vehicle sends its vehicle state information to a vehicle back-end server, preferably the vehicle sends its vehicle state information to the vehicle back-end server periodically or in response to plugging of the charging gun into the vehicle.

According to a third aspect of the present disclosure, a charging pile is provided. The charging pile is configured to implement the method for authentication of charging a vehicle according to the present disclosure. The charging pile comprises:
a charging communication unit, configured to communicate with the vehicle after plugging a charging gun of the charging pile into the vehicle, so as to receive a vehicle identification number and at least one vehicle state information from the vehicle; and
a remote communication unit, configured to communicate with a remote server to send the vehicle identification number and the vehicle state information derived from the vehicle, so as to compare with the vehicle state information sent by the vehicle for authentication.

In the charging pile according to the present disclosure, the charging communication unit may communicate with the battery management unit or BMS of the vehicle so as to obtain the vehicle identification number and the at least one vehicle state information. The remote communication unit of the charging pile communicates with the remote server so as to send the vehicle identification number and the vehicle state information derived from the vehicle and to receive an authentication result from the remote server, for example a signal representing that the authentication is passed and a signal representing that the authentication fails, and the charging pile may allow or prohibit the charging of the vehicle accordingly.

According to one embodiment of the present disclosure, the charging pile communicates with the vehicle via CAN line, PLC line, RS-485 line or Ethernet line, preferably the communication is performed in accordance with the GB/T27930-2015 standard; and/or the charging pile charges the vehicle in accordance with GB/T 18487.1-2015, CCS 1, CCS 2, CHAdeMO or ChaoJi standard.

According to a fourth aspect of the present disclosure, a system for authentication of charging a vehicle is provided. The system comprises:
the vehicle according to the present disclosure;
the charging pile according to the present disclosure; and
a remote server configured to:
   receive, from the vehicle, its vehicle state information,
   receive, from the charging pile, a vehicle identification number and vehicle state information derived from the vehicle,
   compare the vehicle state information sent by the vehicle with the vehicle state information sent by the charging pile for the vehicle identification number, and
   pass the authentication if at least one item in the vehicle state information matches.

According to one embodiment of the present disclosure, the vehicle state information is provided with a time stamp such that whether the time stamp has expired is additionally checked in the remote server.

According to one embodiment of the present disclosure, the remote server includes a vehicle back-end server and a charging operator server, and the vehicle state information of the vehicle is sent by the vehicle to the vehicle back-end server, and the vehicle identification number and the vehicle state information derived from the vehicle is sent by the charging pile to the charging operator server, and the comparison of the vehicle state information is implemented in one of the vehicle back-end server and the charging operator server.

According to one embodiment of the present disclosure, the remote server is in communication connection with a mobile terminal of a vehicle user so as to interact with the vehicle user for charging data and/or fee bills. Therefore, the vehicle user may know the charging data in real time by means of his or her mobile terminal, for example the current state of charge of the battery and the estimated charging time; the vehicle user may also conveniently set the charging data by means of his or her mobile terminal, for example reserving the charging and setting the charging data; and/or the vehicle user may pay fee bills by means of his or her mobile terminal.

It should be noted that, the features, elements, functions, effects and advantages according to one aspect of the present disclosure may also refer to the above-described descriptions according to other aspects of the present disclosure. In addition, various aspects described in this document may be combined with each other in various ways.

### BRIEF DESCRIPTION OF THE DRAWINGS

FIG. 1 shows a flowchart of the method for authentication of charging a vehicle according to one embodiment of the present disclosure;

FIG. 2 shows a flowchart of the method for authentication of charging a vehicle according to another embodiment of the present disclosure;

FIG. 3 shows a schematic view of the system for authentication of charging a vehicle according to one embodiment of the present disclosure, in which the vehicle according to the present disclosure and the charging pile according to the present disclosure are schematically shown respectively; and

FIG. 4 shows a schematic view of the system for authentication of charging a vehicle according to another embodiment of the present disclosure.

### EMBODIMENTS

In order to make the above-described object, features and advantages of the present disclosure more apparent and understandable, detailed explanations are made to the specific embodiments of the present disclosure in combination with the drawings as follows.

In the following description, specific details are set forth in order to facilitate an adequate understanding of the present disclosure. However, the present disclosure can be implemented in multiple manners other than those described herein, and those skilled in the art may make similar promotion without departing from the spirit of the present disclosure. Therefore, the present disclosure is not limited by the specific embodiments disclosed below.

The meaning of the expression “and/or” used herein is to include at least one of the assemblies listed before and after the expression. Moreover, the meaning of the expression “connection” used is to include direct connection with another assembly or indirect connection through another assembly such as a cable. The singular forms herein also include the plural forms, unless particularly mentioned in the wording. Also, the meaning of the assemblies, steps, operations, and units used herein which involve “comprising” or “containing”, is to be present with or add at least one other assembly, step, operation, and unit.

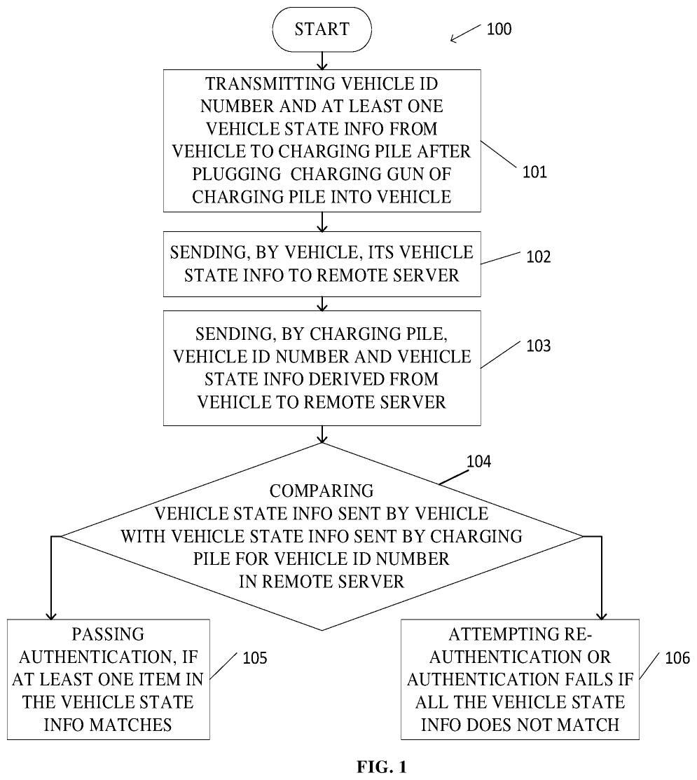

FIG. 1 shows a flowchart of the method 100 for authentication of charging a vehicle according to one embodiment of the present disclosure. The method 100 comprises:

Step 101: a vehicle identification number and at least one vehicle state information are transmitted from the vehicle to a charging pile after plugging a charging gun of the charging pile into the vehicle;

Step 102: the vehicle sends its vehicle state information to a remote server;

Step 103: the charging pile sends the vehicle identification number and the vehicle state information derived from the vehicle to the remote server;

Step 104: the vehicle state information sent by the vehicle is compared with the vehicle state information sent by the charging pile for the vehicle identification number in the remote server; and

Step 105: the authentication is passed if at least one item in the vehicle state information matches.

At this time, the remote server may return a signal representing that the authentication is passed to the charging pile, so as to allow the charging pile to charge the vehicle.

In addition, the method 100 may further include Step 106: re-authentication is attempted or the authentication fails if all the vehicle state information does not match. Here, re-authentication is attempted, so that it is possible to perform steps 101 to 105, or some of the steps again, or choose to other vehicle state information for authentication. It is particularly advantageous that, in the case that the first authentication fails before charging starts, the charging pile first starts charging the vehicle, and the authentication is attempted again during the charging. If the authentication fails again, the remote server returns a signal representing that the authentication fails to the charging pile, so as to prohibit or stop the charging pile from charging the vehicle.

It should be noted that, in the method 100, the order of step 101 and step 102 may be reversed. Preferably, the vehicle may also periodically send its vehicle state information to the remote server, in particular to the vehicle back-end server.

Preferably, the vehicle state information is real-time vehicle state information, in particular the vehicle state information is provided with a time stamp. Since the vehicle identification number and the at least one vehicle state information transmitted from the vehicle to the charging pile are usually generated or obtained at the same moment, it is more preferable that the vehicle state information transmitted by the vehicle to the remote server is provided with a time stamp. Whether the time stamp has expired may be additionally checked in the remote server. In particular, the vehicle state information sent by the vehicle is compared with the vehicle state information sent by the charging pile only in the case where the time stamp has not expired.

Advantageously, the vehicle state information includes one or more of the following: current state of charge of battery, current voltage of battery, charging times of battery, plug state, measured value of charging voltage, measured value of charging current, and location data, etc.; and/or the vehicle identification number is vehicle unique identification number VIN, vehicle frame number or vehicle engine number, etc. In the present disclosure, a plurality of, in particular three vehicle state information are preferably used for authentication. For the plurality of vehicle state information, any combination of the above-described data may be arbitrarily selected, and a combination of the current state of charge of battery, the plug state, and the location data is particularly preferred. Here, there is no need to send the location data from the vehicle to the charging pile. Rather, in the remote server, the location data sent by the vehicle to the remote server is compared with the location data of the charging pile pre-stored in the remote server.

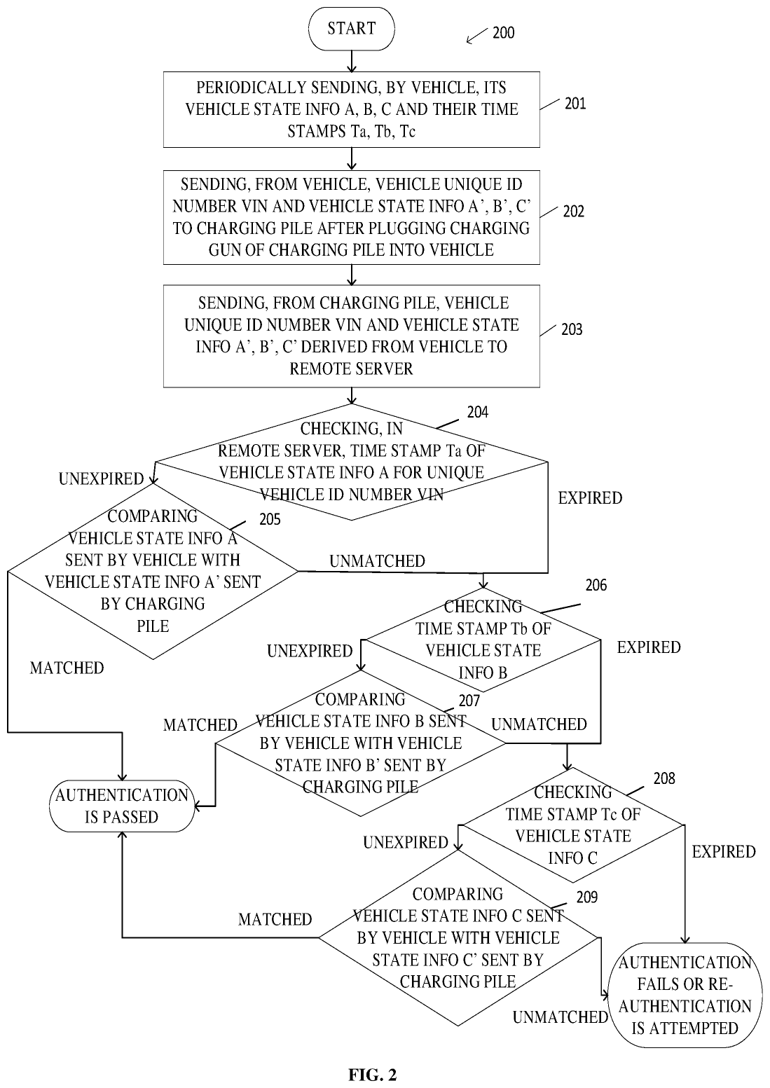

FIG. 2 shows a flowchart of the method 200 for authentication of charging a vehicle according to another embodiment of the present disclosure. Here, three different vehicle state information are used for authentication, and the vehicle state information from the vehicle to the remote server is provided with a corresponding time stamp respectively.

After the method 200 starts, first of all, in step 201, the vehicle sends its vehicle state information A and its time stamp Ta, its vehicle state information B and its time stamp Tb, and its vehicle state information A and its time stamp Tc periodically or at a predetermined time interval. In step 202, a vehicle unique identification number VIN and a vehicle state information A′, B′, C′ are sent from the vehicle to a charging pile after plugging a charging gun of the charging pile into the vehicle. In step 203, the charging pile sends the vehicle unique identification number VIN and the vehicle state information A′, B′, C′ derived from the vehicle to the remote server.

Next, in step 204, in the remote server, for the same unique vehicle identification number VIN, it is first checked whether the time stamp Ta of the vehicle state information A has expired. If the time stamp Ta does not exceed a predetermined time threshold, for example 1 minute, the vehicle state information A sent by the vehicle is compared with the vehicle state information A′ sent by the charging pile in step 205. If both of them match, the authentication is passed. However, if the time stamp Ta exceeds a predetermined time threshold or the time stamp Ta has expired or the vehicle state information A sent by the vehicle does not match the vehicle state information A′ sent by the charging pile, then in step 206, the time stamp Tb of the vehicle state information B is further checked. If the time stamp Tb has not expired, the vehicle state information B sent by the vehicle is compared with the vehicle state information B′ sent by the charging pile in step 207. If both of them match, the authentication is also passed. However, if the time stamp Tb has expired or the vehicle state information B sent by the vehicle does not match the vehicle state information B′ sent by the charging pile, then in step 208, the time stamp Tc of the vehicle state information C is further checked. If the time stamp Tc has not expired, the vehicle state information C sent by the vehicle is compared with the vehicle state information C′ sent by the charging pile in step 209. If both of them match, the authentication is also passed. However, if the time stamp Tc has expired or the vehicle state information C sent by the vehicle does not match the vehicle state information C′ sent by the charging pile, the authentication fails finally or an attempt for re-authentication may be considered. Here, the re-authentication is attempted, so that it is possible to perform steps 201 to 209, or some of the steps again, or choose other vehicle state information for authentication.

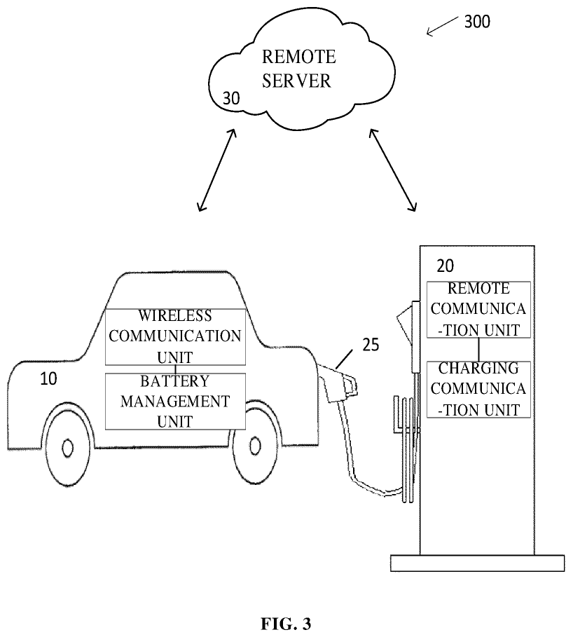

FIG. 3 shows a schematic view of the system 300 for authentication of charging a vehicle according to one embodiment of the present disclosure, in which the vehicle 10 according to the present disclosure and the charging pile 20 according to the present disclosure are schematically shown respectively.

FIG. 3 shows the vehicle 10 according to one embodiment of the present disclosure, which is configured to implement the method for authentication of charging a vehicle according to the present disclosure. The vehicle 10 comprises:
a battery management unit configured to communicate with a charging pile 20 after plugging a charging gun 25 of the charging pile 20 into the vehicle 10, so as to transmit a vehicle identification number and at least one vehicle state information; and
a wireless communication unit, configured to communicate with a remote server 30 to send the vehicle state information, wherein the vehicle state information is used to compare with the vehicle state information sent by the charging pile 20 for authentication.

Preferably, the vehicle state information, in particular the vehicle state information sent by the vehicle 10 to the remote server 30, is provided with a time stamp such that whether the time stamp has expired may be additionally checked in the remote server 30.

FIG. 3 also shows the charging pile 20 according to one embodiment of the present disclosure, which is configured to implement the method for authentication of charging a vehicle according to the present disclosure. The charging pile 20 comprises:
a charging communication unit, configured to communicate with the vehicle 10 after plugging a charging gun 25 of the charging pile 20 into the vehicle 10, so as to receive a vehicle identification number and at least one vehicle state information from the vehicle 10; and
a remote communication unit, configured to communicate with a remote server 30 to send the vehicle identification number and the vehicle state information derived from the vehicle 10, so as to compare with the vehicle state information sent by the vehicle 10 for authentication.

Advantageously, the communication between the charging pile 20 and the vehicle 10 may be implemented via CAN line, PLC line, RS-485 line or Ethernet line. Preferably, the charging pile 20 is a DC charging pile and communicates with the vehicle 10 particularly according to the GB/T27930-2015 standard. Also preferably, the charging pile 20 charges the vehicle 10 according to GB/T 18487.1-2015, CCS 1, CCS 2, CHAdeMO or ChaoJi standard.

FIG. 3 generally shows the system 300 for authentication of charging a vehicle according to one embodiment of the present disclosure. The system 300 comprises:
the vehicle 10 as described above;
the charging pile 20 as described above; and
a remote server 30 configured to:
   receive its vehicle state information from the vehicle 10,
   receive, from the charging pile 20, a vehicle identification number and vehicle state information derived from the vehicle 10,
   compare the vehicle state information sent by the vehicle 10 with the vehicle state information sent by the charging pile 20 for the vehicle identification number, and
   pass the authentication if at least one item in the vehicle state information matches.

In the case where the vehicle state information, in particular the vehicle state information sent by the vehicle 10 to the remote server 30, is provided with a time stamp, whether the time stamp has expired is additionally checked in the remote server 30. For this purpose, the authentication may be performed with reference to the flow of the method shown in FIG. 2.

In order to avoid misunderstandings by the vehicle user, it is advantageously provided that, in the case that the first authentication fails before charging starts, the charging pile 20 first starts charging the vehicle 10, and the system 300 attempts the authentication again during the charging.

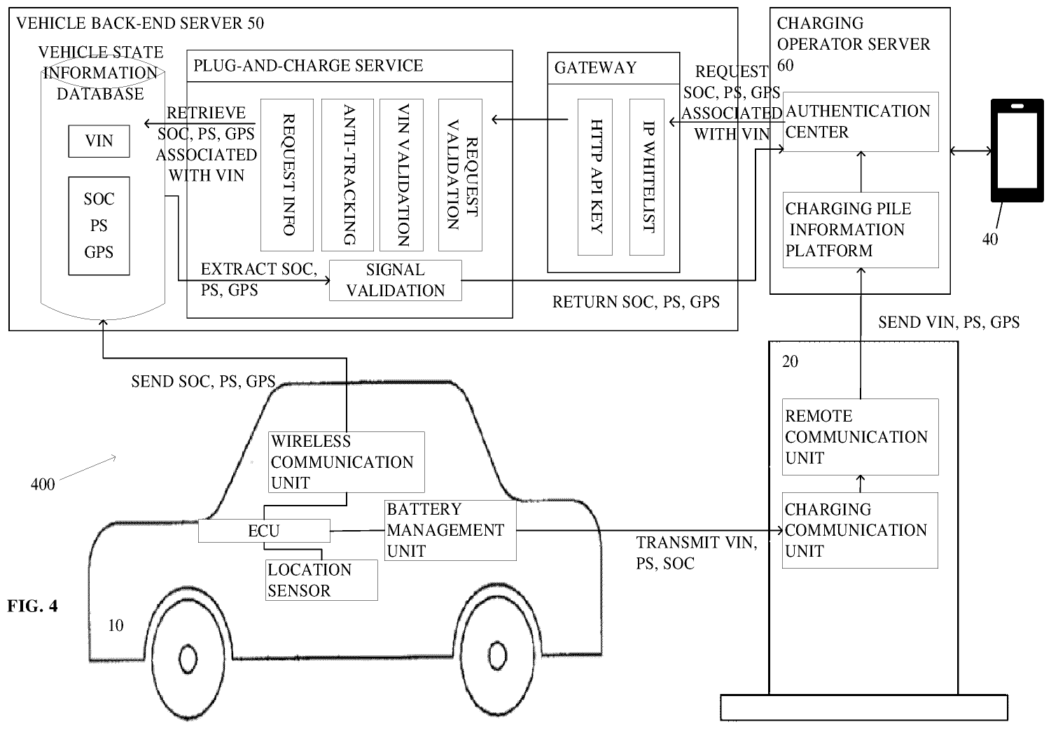

FIG. 4 shows a schematic view of the system 400 for authentication of charging a vehicle according to another embodiment of the present disclosure. Here, in order to protect the information of the vehicle user on the one hand and allow for utilizing the data services available in the vehicle manufacturer or the vehicle service provider on the other hand, the remote server 30 is separately implemented in a vehicle back-end server 50 and a charging operator server 60. The vehicle 10 sends its vehicle state information to the vehicle back-end server 50, and the charging pile 20 sends the vehicle identification number and the vehicle state information derived from the vehicle 10 to the charging operator server 60, and the comparison of the vehicle state information is implemented in one of the vehicle back-end server 50 and the charging operator server 60 (the charging operator server 60 in FIG. 4).

The basic architecture of the vehicle back-end server 50 and the charging operator server 60 is shown exemplarily in FIG. 4. The vehicle back-end server 50 may mainly include a vehicle state information database, a plug-and-charge service, and a gateway. The charging operator server 60 may include an authentication center and a charging pile information platform. The charging operator server 60 may also be communicatively connected with the mobile terminal 40 of the vehicle user so as to interact with the vehicle user for charging data and/or fee bills. Therefore, the vehicle user may know the charging data, set the charging data and pay fee bills by means of his or her mobile terminal 40.

FIG. 4 also shows another embodiment of the vehicle 10 according to the present disclosure. In addition to the battery management unit and the wireless communication unit, an electronic control unit (ECU) is also shown in the vehicle 10. The electronic control unit performs data interaction with the location sensor, the battery management unit and the wireless communication unit through the vehicle bus. The electronic control unit may obtain the location data GPS of the vehicle from the location sensor. The location data GPS may be transmitted to the wireless communication unit via the electronic control unit for outgoing transmission. The battery management unit may detect the plug state PS and the state of charge SOC of the battery. The plug state PS and the state of charge SOC of the battery may be transmitted to the wireless communication unit directly or via the electronic control unit for outgoing transmission. Here, the wireless communication unit may send the vehicle state information to the vehicle back-end server 50 periodically or in response to the charging gun 25 being plugged into the vehicle 10.

Hereinafter, referring to FIG. 4, the data interaction in the authentication of charging a vehicle will be described in one preferred embodiment of the present disclosure. Here, three vehicle state information in total are used for authentication: location data GPS, plug state PS and state of charge SOC of the battery; and the vehicle unique identification number VIN is used as the vehicle identification number. Here, the unique vehicle identification number VIN may be pre-stored in the vehicle state information database of the vehicle back-end server 50 so as to prevent the communication between the vehicle and the vehicle back-end server 50 from being monitored and illegally used by others. For this purpose, an additional vehicle ID may be used to identify the vehicle. As described above, the wireless communication unit may transmit the location data GPS, the plug state PS and the state of charge SOC of the battery to the vehicle back-end server 50 through the wireless communication network periodically or in response to the charging gun 25 being plugged into the vehicle 10. The vehicle back-end server 50 stores the received vehicle state information in the vehicle state information database so as to subsequently compare with the vehicle state information sent by the charging pile 20 for authentication.

After the charging gun 25 of the charging pile 20 is plugged into the vehicle 10, the vehicle unique identification number VIN, the plug state PS and the state of charge SOC of the battery are transmitted from the vehicle 10 to the charging communication unit of the charging pile 20. Here, these data may be transmitted in the BCP message and the BCS message specified in the GB/T27930-2015 standard. As described above, in the case of using the location data GPS as the vehicle state information, the vehicle 10 only sends the location data GPS to the vehicle back-end server 50 without transmitting the location data GPS to the charging pile 20. Since the vehicle 10 is required to be proximate to the charging pile 20 in position during charging, the location data of the vehicle is substantially equivalent to the location data of the charging pile, so that in the present disclosure, it is possible to advantageously use the location data for authentication without being restricted by the limited fields specified by the communication standard between the vehicle 10 and the charging pile 20, and at the same time greatly improve the safety of the authentication. Therefore, the vehicle state information sent by the vehicle 10 to the charging pile 20 in the present disclosure may be partially different from the vehicle state information sent by the vehicle 10 to the remote server 30 or the vehicle back-end server 50.

The charging communication unit of the charging pile 20 transmits the unique vehicle identification number VIN, the plug state PS and the state of charge SOC of the battery derived from the vehicle 1 to the remote communication unit. The remote communication unit implements the transmission to the charging operator server 60 by means of a wired network or a wireless network.

After receiving the above-described information, the charging pile information platform of the charging operator server 60 transmits the same to the authentication center, which then requests the location data GPS, the plug state PS, and the state of charge SOC of the battery associated with the vehicle unique identification number VIN from the vehicle back-end server 50.

A gateway provided with an IP white list and an HTTP API key is set in the vehicle back-end server 50 for defending against attacks. The request from the authentication center is transmitted to the plug-and-charge service via the gateway, in which functions such as verification request, verification of the vehicle unique identification number VIN and anti-tracking may be realized. After the verification is passed, the vehicle state information database is requested to retrieve the location data GPS, the plug state PS, and the state of charge SOC associated with the vehicle unique identification number VIN. After the vehicle state information is extracted from the vehicle state information database, the vehicle state information is returned to the authentication center of the charging operator server 60.

The authentication center of the charging operator server 60 may compare the vehicle state information returned by the vehicle back-end server 50 and the vehicle state information sent by the charging pile 20 one by one for the unique vehicle identification number VIN. Here, the plug state PS returned by the vehicle back-end server 50 is compared with the plug state PS derived from the vehicle 10 sent by the charging pile 20; the state of charge SOC returned by the vehicle back-end server 50 is compared with the state of charge SOC derived from the vehicle 10 sent by the charging pile 20; and the location data GPS returned by the vehicle back-end server 50 is compared with the location data of the charging pile pre-stored in the charging operator server 60. The authentication is passed if at least one item of the vehicle state information matches (they are the same or the difference is within the allowable error range). Thus, the charging operator server 60 may instruct the charging pile 20 to start charging the vehicle 10.

The above-described three vehicle state information may likewise be advantageously provided with a time stamp. The vehicle back-end server 50 transmits their corresponding time stamp when returning the location data GPS, the plug state PS and the state of charge SOC of the battery. In this regard, the authentication center may perform authentication of charging a vehicle according to the flow of the method shown in FIG. 2.

In the case that the first authentication fails before charging starts, the charging pile 20 first temporarily starts charging the vehicle 10, and the system 400 may attempt the authentication again during the charging. If the re-authentication also fails, the charging operator server 60 may instruct the charging pile 20 to prohibit or stop charging the vehicle 10.

The present disclosure may also be a computer program product. The computer program product may include computer-readable storage medium having computer-readable program instructions thereon for causing a processor to perform various aspects of the present disclosure. The computer-readable program instruction may be executed entirely on the user's computer, partly on the user's computer, executed as an independent software package, partly on the user's computer and partly executed on a remote computer, or entirely executed on the remote computer or server. In some embodiments, an electronic circuit system including, for example, a programmable logic circuit system, a field programmable gate array (FPGA), or a programmable logic array (PLA) may execute computer-readable program instructions by using state information of computer readable program instructions of a personalized electronic circuit system, so as to perform various aspects of the present disclosure.

Various aspects of the present disclosure have been described herein with reference to the flowchart and/or block diagram of the method, vehicle, charging pile, system, and computer program product according to the embodiments of the present disclosure. It should be understood that each block in the flowchart and/or block diagram and a combination of blocks in the flowchart and/or block diagram may be implemented by computer-readable program instructions.

The present disclosure is not limited to the embodiments shown, but includes or encompasses all technical equivalents that may fall within the effective scope of the appended claims. The positional specification selected in the specification, for example, up, down, left, right, and the like, refers to direct description and the illustrated accompanying drawings and can be transferred for use in new positions according to the meanings when the positions change.

The features disclosed in the present application which may be implemented individually and in any combined manner, are important for implementing aspects of different design solutions and may be realized.

Although some aspects are depicted in association with the device, it should be understood that: these aspects also pertain to descriptions of a corresponding method, such that a unit of a device or an apparatus of a system may also be understood as one step of the corresponding method or one feature of the step of the method. Similar to this, aspects depicted in association with one step of the method or as one step of the method also pertain to descriptions of corresponding modules, details or features of the corresponding device.

Moreover, another embodiment is a data stream, a signal order, or a signal sequence, which is a program for implementing one of the methods described herein. The data stream, signal order or signal sequence may, for example, be configured for transmission via a data communication connection, for example via Internet or other networks. Thus, the embodiment may also be a signal sequence representing data, which is adapted to be sent via a network or data communication connection, wherein the data is a program.

Although the present disclosure has been disclosed in preferred embodiments as above, they are not intended to limit the present disclosure. Any person skilled in the art may make possible changes and modifications to the technical solution of the present disclosure using the above-described method and technical content as disclosed without departing from the spirit and scope of the present disclosure. Therefore, for the content not departing from the technical solution of the present disclosure, any simple modifications, equivalent changes and decorations to the above embodiments according to the technical essence of the present disclosure fall within the protection scope of the technical solution of the present disclosure.

1.-19. (canceled)

20. A method for authentication of charging a vehicle, the method comprising:
transmitting a vehicle identification number and at least one vehicle state information from the vehicle to a charging pile after plugging a charging gun of the charging pile into the vehicle;
sending, by the vehicle, its vehicle state information to a remote server;
sending, by the charging pile, the vehicle identification number and the vehicle state information derived from the vehicle to the remote server;
comparing the vehicle state information sent by the vehicle with the vehicle state information sent by the charging pile for the vehicle identification number in the remote server; and
passing the authentication if at least one item in the vehicle state information matches.

21. The method according to claim 20, wherein
the vehicle state information is real-time vehicle state information provided with a time stamp such that whether the time stamp has expired is additionally checked in the remote server.

22. The method according to claim 20, wherein
the vehicle state information includes one or more of:
current state of charge of battery, current voltage of battery, charging times of battery, plug state, measured value of charging voltage, measured value of charging current, and location data; and/or
the vehicle identification number is a vehicle unique identification number, a vehicle frame number or a vehicle engine number.

23. The method according to claim 22, wherein
in the case of using the location data as the vehicle state information, the vehicle only sends the location data to the remote server, such that the remote server correspondingly compares the location data sent by the vehicle with the location data of the charging pile stored in the remote server.

24. The method according to claim 20, wherein
in the case that the authentication fails before charging starts, the charging pile first starts charging the vehicle, and the authentication is attempted again during the charging.

25. The method according to claim 20, wherein
the vehicle sends its vehicle state information to a vehicle back-end server,
the charging pile sends the vehicle identification number and the vehicle state information derived from the vehicle to a charging operator server, and
the comparison of the vehicle state information is implemented in one of: the vehicle back-end server or the charging operator server.

26. The method according to claim 25, wherein
the vehicle sends its vehicle state information to the vehicle back-end server periodically or in response to plugging of the charging gun into the vehicle.

27. The method according to claim 20, wherein
the communication between the vehicle and the charging pile is implemented via CAN line, PLC line, RS-485 line or Ethernet line.

28. The method according to claim 27, wherein
the communication is performed in accordance with the GB/T27930-2015 standard; and/or
the vehicle and the charging pile are implemented in accordance with GB/T 18487.1-2015, CCS 1, CCS 2, CHAdeMO or ChaoJi standard.

29. A vehicle, comprising:
a battery management unit configured to communicate with a charging pile after plugging a charging gun of the charging pile into the vehicle so as to transmit a vehicle identification number and at least one vehicle state information; and
a wireless communication unit configured to communicate with a remote server to send the vehicle state information, wherein
the vehicle state information is used to compare with the vehicle state information sent by the charging pile for authentication.

30. The vehicle according to claim 29, wherein
the vehicle state information is real-time vehicle state information provided with a time stamp.

31. The vehicle according to claim 29, wherein
the vehicle state information includes one or more of:
current state of charge of battery, current voltage of battery, charging times of battery, plug state, measured value of charging voltage, measured value of charging current, and location data; and/or
the vehicle identification number is vehicle unique identification number, a vehicle frame number or a vehicle engine number.

32. The vehicle according to claim 29, wherein
the vehicle sends its vehicle state information to a vehicle back-end server periodically or in response to plugging of the charging gun into the vehicle.

33. A charging pile for charging a vehicle, comprising:
a charging communication unit configured to communicate with the vehicle after plugging a charging gun of the charging pile into the vehicle so as to receive a vehicle identification number and at least one vehicle state information from the vehicle; and
a remote communication unit configured to communicate with a remote server to send the vehicle identification number and the vehicle state information derived from the vehicle so as to compare with the vehicle state information sent by the vehicle for authentication.

34. The charging pile according to claim 33, wherein
the charging pile communicates with the vehicle via CAN line, PLC line, RS-485 line or Ethernet line, and the communication is performed in accordance with the GB/T27930-2015 standard; and/or
the charging pile charges the vehicle in accordance with GB/T 18487.1-2015, CCS 1, CCS 2, CHAdeMO or ChaoJi standard.

35. A system for authentication of charging a vehicle, the system comprising:
a vehicle comprising:
a battery management unit configured to communicate with a charging pile after plugging a charging gun of the charging pile into the vehicle so as to transmit a vehicle identification number and at least one vehicle state information; and
a wireless communication unit configured to communicate with a remote server to send the vehicle state information, wherein the vehicle state information is used to compare with the vehicle state information sent by the charging pile for authentication.
a charging pile comprising:
a charging communication unit configured to communicate with the vehicle after plugging the charging gun of the charging pile into the vehicle so as to receive the vehicle identification number and the at least one vehicle state information from the vehicle; and
a remote communication unit configured to communicate with the remote server to send the vehicle identification number and the vehicle state information derived from the vehicle so as to compare with the vehicle state information sent by the vehicle for authentication, wherein
the remote server is configured to:
receive, from the vehicle, its vehicle state information,
receive, from the charging pile, the vehicle identification number and the vehicle state information derived from the vehicle,
compare the vehicle state information sent by the vehicle with the vehicle state information sent by the charging pile for the vehicle identification number, and
pass the authentication if at least one item in the vehicle state information matches.

36. The system according to claim 35, wherein
the vehicle state information is provided with a time stamp such that whether the time stamp has expired is additionally checked in the remote server.

37. The system according to claim 35, wherein
in the case that the authentication fails before charging starts, the charging pile first starts charging the vehicle, and the system attempts the authentication again during the charging.

38. The system according to claim 35, wherein
the remote server includes a vehicle back-end server and a charging operator server, and
the vehicle state information of the vehicle is sent by the vehicle to the vehicle back-end server, and
the vehicle identification number and the vehicle state information derived from the vehicle is sent by the charging pile to the charging operator server, and
the comparison of the vehicle state information is implemented in one of: the vehicle back-end server or the charging operator server.

39. The system according to claim 35, wherein
the remote server is in communication connection with a mobile terminal of a vehicle user so as to interact with the vehicle user for charging data and/or fee bills.
